(19) United States
(12) Patent Application Publication
(10) Pub. No.: US 2026/0249460 A1
(43) Pub. Date: Aug. 27, 2026

(54) AUTOMATION SUPPORT APPARATUS AND AUTOMATION SUPPORT METHOD

(71) Applicant: PANASONIC INTELLECTUAL PROPERTY MANAGEMENT CO., LTD., Osaka (JP)

(72) Inventors: Suguru NAKAO, Hyogo (JP); Satoru SHIBATA, Osaka (JP); Taishi ISOZAKI, Osaka (JP)

(73) Assignee: PANASONIC INTELLECTUAL PROPERTY MANAGEMENT CO., LTD., Osaka (JP)

(21) Appl. No.: 19/545,610

(22) Filed: Feb. 20, 2026

(30) Foreign Application Priority Data
Feb. 21, 2025 (JP) 2025-027177

(51) Int. Cl. B25J 9/16

(52) U.S. Cl. CPC B25J 9/1664; B25J 9/1679

(57) ABSTRACT

An automation support apparatus for supporting automation of a pick-and-place work includes a memory storing instructions; and a processor that implements the instructions to specify an object condition related to an object to be picked and placed, a picking condition related to picking of the object, and a placing condition related to placing of the object, determine a quantitative difficulty level for automating the work based on the specified object condition, picking condition, and placing condition, and cause a display device to display the quantitative difficulty level.

### CROSS-REFERENCE TO RELATED APPLICATIONS

This application is based on and claims priority under 35 USC 119 from Japanese Patent Application No. 2025-027177 filed on Feb. 21, 2025, the contents of which are incorporated herein by reference.

### TECHNICAL FIELD

The present disclosure relates to an automation support apparatus and an automation support method.

### BACKGROUND ART

In the related art, a process planning support apparatus is known that supports a planning of a process for various works. The process planning support apparatus includes: a setting unit configured to set allocation of works with respect to each of work stations in an assembly line; a first calculation unit configured to calculate work times corresponding to work subjects of the work stations based on library data of each of unit works, in which each unit work is expressed by a combination of element works each having motions as constituent elements, for the works allocated to the work stations, respectively; a second calculation unit configured to calculate evaluation indexes of the work stations based on the calculated work times, respectively; and an output unit configured to output the calculated evaluation indexes (see Patent Literature 1).

The second calculation unit calculates a cycle time or a cost of each of the work stations based on the calculated work times. The unit work has information such as an automation difficulty level. The automation difficulty level indicates the difficulty level in a case in which a work is performed by a robot. For example, when a work is performed by a robot, the cost of the work is obtained based on the automation difficulty level. For example, when the difficulty level of a work performed by a robot is high, the initial cost of the robot becomes high and thus the cost may be calculated to be high according to the height of the automation difficulty level (see Patent Literature 1).

### CITATION LIST

### Patent Literature

Patent Literature 1: JP2018-026071A

### SUMMARY OF INVENTION

The present disclosure provides an automation support apparatus and an automation support method that can evaluate the difficulty level of automating a work by taking into account various conditions related to pick-and-place.

One aspect of the present disclosure is an automation support apparatus for supporting automation of a pick-and-place work. The automation support device includes a memory storing instructions; and a processor that implements the instructions to specify an object condition related to an object to be picked and placed, a picking condition related to picking of the object, and a placing condition related to placing of the object, determine a quantitative difficulty level for automating the work based on the specified object condition, picking condition, and placing condition, and cause a display device to display the quantitative difficulty level.

Further, another aspect of the present disclosure is an automation support method for supporting automation of a pick-and-place work. The automation support method includes specifying an object condition related to an object to be picked and placed, a picking condition related to picking of the object, and a placing condition related to placing of the object; determining a quantitative difficulty level for automating the work based on the specified object condition, picking condition, and placing condition; and causing a display device to display the quantitative difficulty level.

According to the present disclosure, the difficulty level of automating a work can be evaluated by taking into account various conditions related to pick-and-place.

### BRIEF DESCRIPTION OF DRAWINGS

FIG. 1 is a block diagram illustrating a configuration example of an automation support apparatus according to a first embodiment;

FIG. 2 is a flowchart illustrating an operation example of the automation support apparatus according to the first embodiment;

FIG. 3 is a flowchart illustrating an example of input data acquisition processing;

FIG. 4 is a flowchart illustrating an example of picking condition specification processing;

FIG. 5 is a flowchart illustrating an example of placing condition specification processing;

FIG. 6 is a flowchart illustrating an example of object condition specification processing;

FIG. 7 is a flowchart illustrating an example of surrounding condition specification processing;

FIG. 8 is a diagram illustrating an example of difficulty level points according to specified contents of each condition related to a work;

FIG. 9 is a diagram illustrating a method for assigning the difficulty level point according to the specified content for each condition item in a pick-and-place work;

FIG. 10 is a diagram illustrating an example of difficulty level point symbols according to the specified content for each condition item corresponding to Item 1 to 7 in the pick-and-place work;

FIG. 11 is a diagram illustrating an example of technique points, basic points, and difficulty level points related to an automation-required technique according to the specified content corresponding to the difficulty level point symbols;

FIG. 12 is a diagram illustrating an example of the automation-required technique according to the specified contents for each condition related to the work;

FIG. 13 is a diagram illustrating a configuration example of an automation system for automating a predetermined pick-and-place work;

FIG. 14 is a flowchart illustrating an operation example of an automation support apparatus according to a second embodiment;

FIG. 15 is a diagram illustrating an example of a difficulty level point related to a work W1;

FIG. 16 is a diagram illustrating an example of a difficulty level point related to a work W2; and

FIG. 17 is a diagram illustrating a comparative example of the difficulty level points of the two works W1 and W2.

### DESCRIPTION OF EMBODIMENTS

Hereinafter, embodiments will be described in detail with reference to the drawings as appropriate. However, the unnecessarily detailed description may be omitted. For example, detailed description of well-known matters and redundant description of substantially the same configuration may be omitted. This is to avoid unnecessary redundancy in the following description and to facilitate understanding of those skilled in the art. It should be noted that the accompanying drawings and the following description are provided for those skilled in the art to fully understand the present disclosure, and are not intended to limit the subject matter described in the claims.

### Circumstances Leading to Obtaining an Embodiment According to Present Disclosure

When considering the automation of works using robots, specialized knowledge about robots and automated equipment is necessary. Therefore, it is difficult for users considering automation to grasp the difficulty level of implementing automation, making it difficult to determine whether automation is feasible.

In the apparatus according to Patent Literature 1, the cost of a work, which is derived based on the automation difficulty level, can be used as an evaluation index. However, no detailed description is given of how the automation difficulty level is derived. Therefore, it is difficult to accurately derive the automation difficulty level, and it is also difficult to ensure the suitability of an automation system determined based on the automation difficulty level. For example, when picking and placing a predetermined object, it is desirable to take into account various perspectives related to the object, picking, and placing.

In the following embodiments, an automation support apparatus and an automation support method that can evaluate the difficulty level of automating a work by taking into account various conditions related to pick-and-place will be described.

### First Embodiment

### Configuration of Automation Support Apparatus

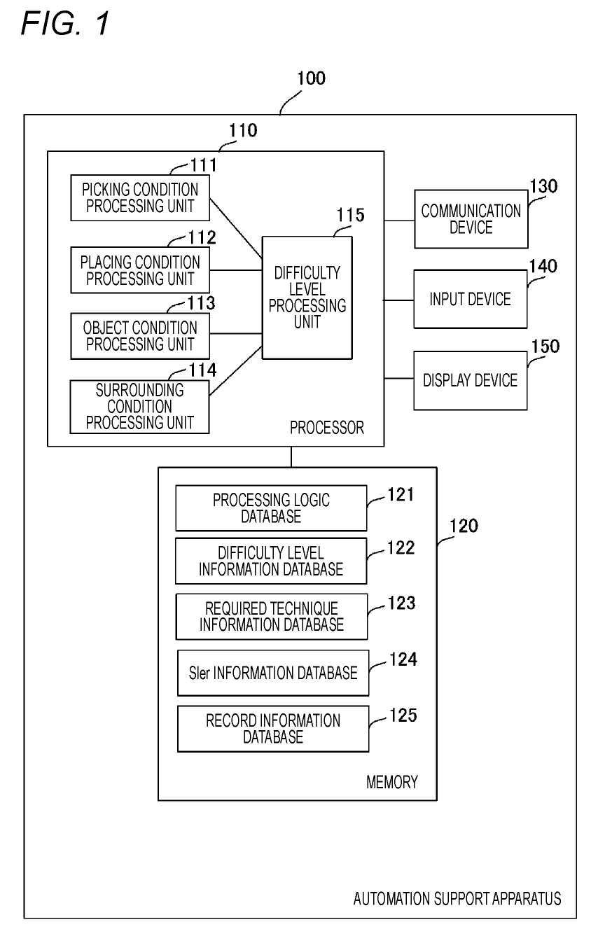

FIG. 1 is a block diagram illustrating a configuration example of an automation support apparatus. An automation support apparatus 100 includes a processor 110, a memory 120, a communication device 130, an input device 140, and a display device 150. The automation support apparatus 100 supports derivation of an automation system that executes each process (for example, a manufacturing process) included in a work. The work includes, for example, a work related to pick-and-place.

The processor 110 may be implemented using, for example, a central processing unit (CPU), a digital signal processor (DSP), or a graphics processing unit (GPU). The processor 110 may be implemented using various integrated circuits (for example, a large-scale integration (LSI) or a field programmable gate array (FPGA)). The processor 110 implements various functions by executing a program stored in the memory 120. The processor 110 integrally controls units of the automation support apparatus 100 and executes various processes.

The memory 120 may include a random access memory (RAM), a read only memory (ROM), a hard disk drive (HDD), a solid state drive (SSD), an optical disk, an SD card, or the like. The memory 120 may be an external storage medium or may be detachable from the automation support apparatus 100. The memory 120 stores various types of data, information, images, programs, trained models, or the like.

The communication device 130 communicates various types of data or information in accordance with a wired or wireless communication method. The communication method by the communication device 130 may include a Local Area Network (LAN), a Wide Area Network (WAN), a cellular phone network, or a communication system such as power line communication.

The input device 140 may include various buttons, keys, a keyboard, a touch panel, a microphone, or other input devices. The input device 140 receives input of various types of data or information. The input device 140 is operated by a user. The user is, for example, a worker or an administrator who automates the pick-and-place work.

The display device 150 is, for example, a liquid crystal display or an organic EL display. The display device 150 displays various types of data or information. The display by the display device 150 may be confirmed by the user, for example.

As an example, the processor 110 has functions as a picking condition processing unit 111, a placing condition processing unit 112, an object condition processing unit 113, a surrounding condition processing unit 114, and a difficulty level processing unit 115.

The picking condition processing unit 111 performs processing related to conditions related to picking of an object (also referred to as picking conditions). For example, the picking condition processing unit 111 receives a user input via the input device 140 and specifies (for example, selects) the picking condition. The picking conditions may be classified into a plurality of condition items (picking condition items).

The placing condition processing unit 112 performs processing related to conditions related to placing of an object (also referred to as placing conditions). For example, the placing condition processing unit 112 receives a user input via the input device 140 and specifies (for example, selects) the placing condition. The placing conditions may be classified into a plurality of condition items (placing condition items).

The object condition processing unit 113 performs processing related to conditions related to an object to be picked and placed (also referred to as object conditions). For example, the object condition processing unit 113 receives a user input via the input device 140 and specifies (for example, selects) the object condition. The object conditions may be divided into a plurality of condition items (object condition items).

The surrounding condition processing unit 114 performs processing related to conditions related to a surrounding work associated with the pick-and-place of the object (also referred to as surrounding conditions). The surrounding work includes, for example, a work of carrying in or out an object, a work of supplying components, a work of picking items from a storage shelve, and other works associated with pick-and-place. For example, the surrounding condition processing unit 114 receives a user input via the input device 140 and specifies (for example, selects) the surrounding condition. The surrounding conditions may be classified into a plurality of condition items (surrounding condition items).

The difficulty level processing unit 115 performs processing related to the difficulty level for automating the pick-and-place work of the object (also referred to as automation difficulty level). The difficulty level processing unit 115 derives (for example, calculates) the automation difficulty level based on at least one of the picking condition specified by the picking condition processing unit 111, the placing condition specified by the placing condition processing unit 112, the object condition specified by the object condition processing unit 113, and the surrounding condition specified by the surrounding condition processing unit 114. The difficulty level processing unit 115 may calculate the automation difficulty level based on the picking condition, placing condition, and object condition, or may calculate the automation difficulty level based on the picking condition, placing condition, object condition, and surrounding condition.

The memory 120 stores various databases, such as a processing logic database 121, a difficulty level information database 122, a required technique information database 123, an SIer information database 124, and a record information database 125.

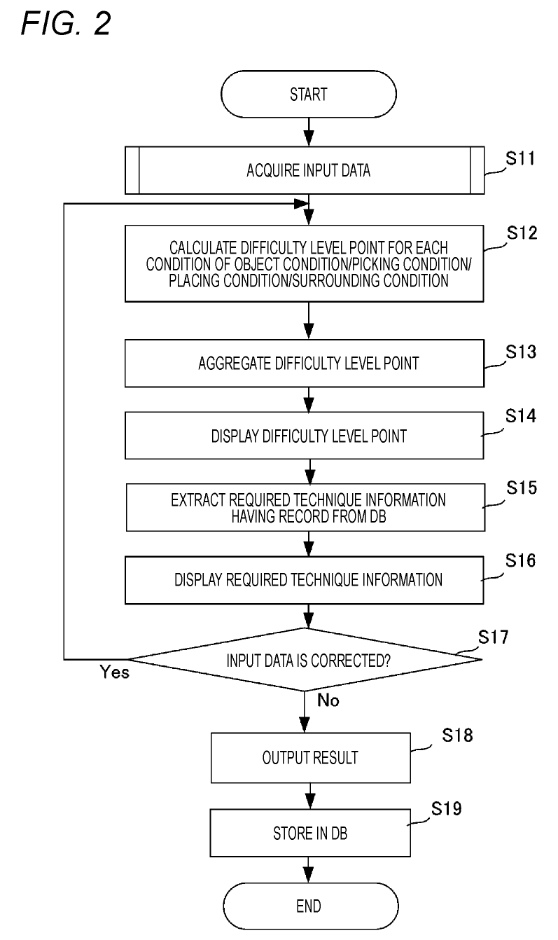

The processing logic database 121 stores information related to processing logic for deriving the automation difficulty level. The processing logic includes, for example, information on an operation flow executed by the automation support apparatus 100 (for example, information in FIGS. 2 to 7).

The difficulty level information database 122 stores difficulty level information related to the difficulty level for automating conditions related to works. The difficulty level information includes, for example, values that quantitatively indicate the difficulty level. In the present embodiment, the conditions related to the works include at least a part of specifiable picking conditions, placing conditions, object conditions, and surrounding conditions, or at least a part of specifiable picking condition items, placing condition items, object condition items, and surrounding condition items. The difficulty level information database 122 stores, for example, for each condition related to a work, information associating the condition with its corresponding difficulty level points.

The required technique information database 123 stores information (also referred to as required technique information) related to techniques required for work automation (also referred to as automation-required technique). The required technique information database 123 stores, for example, information related to the technique required to meet the conditions related to the work (to satisfy the conditions) as required technique information. The required technique information serves as one of solutions for solving the conditions related to the work. The required technique information database 123 stores, for example, for each condition related to the work, information associating the condition with the technique required for solving the condition.

The SIer information database 124 stores information related to system integrators as SIers (also referred to as SIer information). The SIer information stores, for example, identification information that identifies the system integrator, required technique information that the system integrator can handle, and information related to the contact details of the system integrator (such as phone numbers or email addresses), all in association with each other.

The record information database 125 stores automation specification information derived in the past as automation record information, that is, as information on the record in which each condition related to a work is specified. The automation specification information and the automation record information, for example, include at least work identification information that identifies the work and a specified content in which each condition related to the work is specified, all associated with each other. Furthermore, the automation specification information and the automation record information may include, in addition to the work identification information and the specified content, difficulty level information corresponding to the specified content, required technique information corresponding to the specified content, and the like.

Although the automation support apparatus 100 has been described as having each component and each function in one device, the present disclosure is not limited thereto. For example, each component or each function of the automation support apparatus 100 may be arranged in a distributed manner to form a system (automation support system). The system may be implemented by a cloud type on a network or may be implemented by an on-premise type server device.

### Operation of Automation Support Apparatus

Next, an operation of the automation support apparatus 100 will be described.

FIG. 2 is a flowchart illustrating an operation example of the automation support apparatus 100 according to the present embodiment. In FIG. 2, automation of each work related to pick-and-place is assumed.

The processor 110 first receives a user input via the input device 140 and acquires input data (step S11). The input data includes information on specified contents specified for each condition related to the work of picking and placing the object.

The processor 110 calculates the difficulty level point for each condition related to the work, that is, for each condition of the object condition, the picking condition, the placing condition, and the surrounding condition based on the input data (step S12). The difficulty level point indicates, by a quantitative value, a difficulty level for automating the work by satisfying each condition related to the work. The processor 110 aggregates the difficulty level points of each condition related to the work (step S13). The processor 110 causes the display device 150 to display the aggregated difficulty level points as final difficulty level points (step S14).

The processor 110 refers to the required technique information database 123 and extracts required technique information corresponding to each specified condition (that is, each specified content) (step S15). In addition, the processor 110 may extract required technique information having a record as the required technique information corresponding to the specified content in the record information database 125 among the required technique information extracted from the required technique information database 123 (step S15). The processor 110 causes the display device 150 to display the extracted required technique information (step S16). Then, the processor 110 generates automation specification information in which specified contents specified for each condition related to the work are aggregated.

The user checks the displayed information, specifically, the specified content, the difficulty level point with respect to the specified content, the corresponding technique information, and the like, and determines whether the input data needs to be corrected. When the input data needs to be corrected, the input device 140 receives the correction of the input data from the user.

The processor 110 determines whether the input data is corrected, that is, whether there is any correction in the input data (step S17).

When the input data is corrected (Yes in step S17), the processor 110 proceeds to step S12. That is, the processor 110 re-derives and re-displays the difficulty level points, re-extracts and re-displays the required technique information, re-generates the automation specification information, and the like based on the corrected input data.

When the input data is not corrected (No in step S17), the processor 110 outputs the automation specification information based on the corrected or uncorrected input data as a result (step S18). The output of the result here includes causing the display device 150 to display the result.

The processor 110 stores the generated automation specification information in the record information database 125 as the automation record information as a record (step S19).

According to the operation example illustrated in FIG. 2, the automation support apparatus 100 can accurately derive the automation difficulty level by taking into account various conditions related to the work such as the object condition, the picking condition, the placing condition, and the surrounding condition desired by the user. Therefore, the automation support apparatus 100 can ensure the suitability of the automation system determined based on the automation difficulty level.

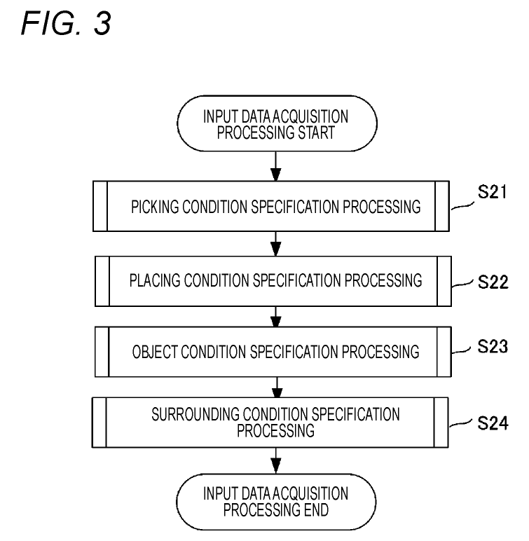

FIG. 3 is a flowchart illustrating an example of input data acquisition processing. Here, it is assumed that the input data is acquired by the user specifying various conditions using the input device 140 on the assumption that various objects are picked and placed.

The processor 110 performs picking condition specification processing of specifying a picking condition (step S21). The processor 110 performs placing condition specification processing of specifying a placing condition (step S22). The processor 110 performs object condition specification processing of specifying an object condition (step S23). The processor 110 performs surrounding condition specification processing of specifying a surrounding condition (step S24).

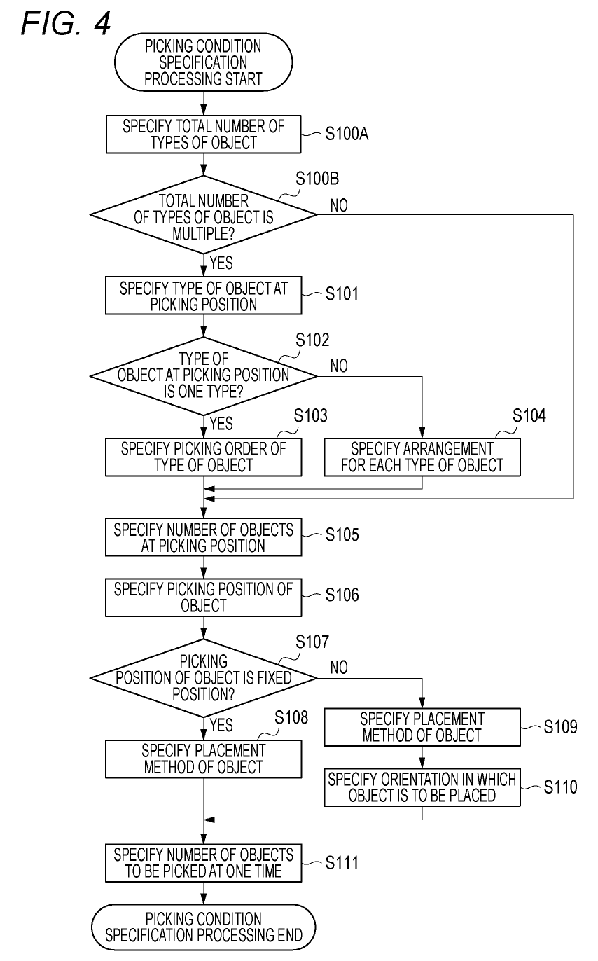

Next, the processing of specifying each condition will be described with reference to FIGS. 4 to 7. In FIGS. 4 to 7, for example, in the processing of specifying each condition, the automation support apparatus 100 may specify each condition by displaying a question for each condition and answering (specifying or selecting) the question. That is, the automation support apparatus 100 may specify each condition in a question answer format using a user interface (UI). In the selection of the answer to the question, the processor 110 selects the answer in a pull-down format, for example, so that the user can easily select the answer.

FIG. 4 is a flowchart illustrating an example of the picking condition specification processing.

The processor 110 specifies the total number of types of objects to be picked and placed (step S100A). In other words, the processor 110 specifies the number of types of corresponding objects in a series of works (works related to pick-and-place) by a robot apparatus.

The processor 110 determines whether the total number of types of the specified objects is multiple (many types) (step S100B). When the total number of types of the specified objects is one (No in step S100B), the processing proceeds to step S105.

When the total number of types of the specified objects is multiple (Yes in step S100B), the processor 110 specifies the type (number of types) of objects at a picking position (step S101). In other words, the processor 110 specifies the number of types of objects to be recognized at the same time as image recognition for picking. The object at the picking position is, for example, an object present at the picking position and is an object to be picked. For example, processor 110 specifies whether the number of types of objects is one or two or more (many types).

In the example of step S101, the processor 110 causes the display device 150 to display question information asking the number of types of objects, and acquires answer information (that is, specified content) to the question information via the input device 140. Similarly, in the following steps, the processor 110 may display question information and input answer information.

The processor 110 determines whether the type of the object at the picking position is one type (step S102).

When there is one type of objects at the picking position (Yes in step S102), the processor 110 specifies a picking order for the one type of objects, that is, the order in which the objects are to be picked (step S103). For example, the processor 110 specifies whether the picking order is a predetermined order, that is, a fixed order, or an order that is not predetermined, that is, a random order.

When there are many types of objects at the picking position (No in step S102), the processor 110 specifies the arrangement of each object for each type of object (step S104). That is, the processor 110 specifies whether the arrangement of the object is a predetermined arrangement, that is, a fixed arrangement, or an arrangement that is not predetermined, that is, a free arrangement for each type of object.

After the processing of step S103 or step S104, the processor 110 specifies the number of objects at the picking position (step S105). For example, the processor 110 specifies the number of objects to be picked at the picking position, for example, specifies whether the number is one or more.

The processor 110 specifies the picking position of the object (step S106). The picking position is, for example, a position in a picking bin in which each object to be picked is stored. For example, the processor 110 specifies whether the picking position is a predetermined position, that is, a fixed position, or a position that is not predetermined, that is, a free position.

The processor 110 determines whether the picking position of the object is the fixed position (step S107).

When the picking position is the fixed position (Yes in step S107), the processor 110 specifies a placement method of the object (step S108). For example, the processor 110 specifies whether to place the objects in a state in which there is no variation in the placement method of the objects (that is, without allowing the variation) or in a state in which there is variation in the placement method of the objects (that is, with allowing the variation).

When the picking position is a free position (No in step S107), the processor 110 specifies the placement method of the object (step S109). For example, the processor 110 specifies whether to place the objects in a state in which the objects overlap each other (that is, with allowing overlap) or in a state in which the objects do not overlap each other (that is, without allowing overlap).

After step S109, the processor 110 specifies an orientation in which the object is to be placed (step S110). For example, the processor 110 specifies whether the orientation in which the object is to be placed is a predetermined orientation, that is, a fixed orientation, or an orientation that is not predetermined, that is, a free orientation.

After step S108 or step S110, the processor 110 specifies the number of objects to be picked at one time (step S111). For example, the processor 110 specifies how many objects are to be picked at the same time, and specifies, for example, one or a plurality of objects to be picked.

According to such picking condition specification processing, the automation support apparatus 100 can determine specified contents for various condition items related to picking and specify the picking condition.

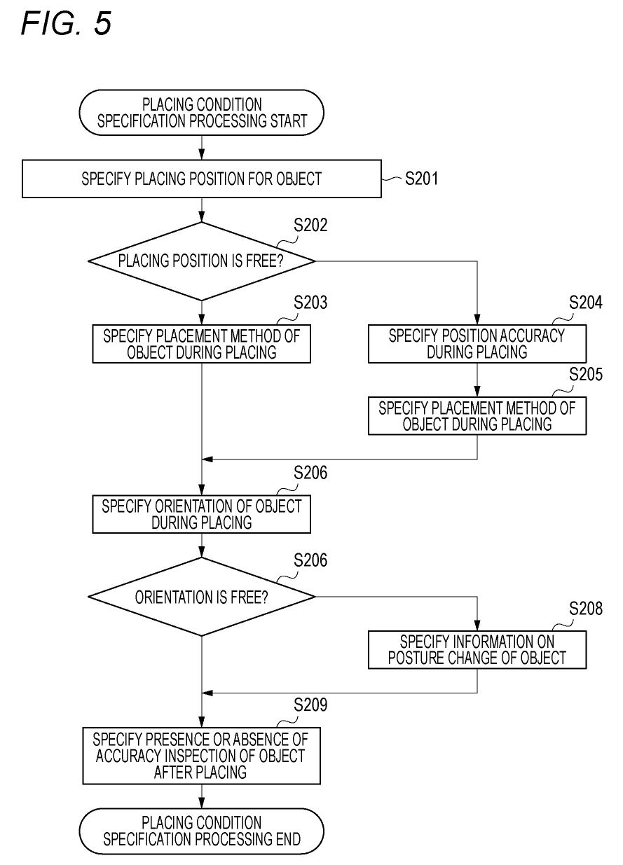

FIG. 5 is a flowchart illustrating an example of the placing condition specification processing.

The processor 110 specifies a placing position for the object (step S201). The placing position is, for example, a position in a placing bin in which each object to be placed is stored. For example, the processor 110 specifies whether the placing position is a predetermined position, that is, a fixed position, or a position that is not predetermined, that is, a free position.

The processor 110 determines whether the placing position is the free position (step S202).

When the placing position is the free position (Yes in step S202), the processor 110 specifies the placement method of the object during placing (step S203). For example, the processor 110 specifies whether each object is aligned in a space in the placing bin or freely placed in the placing bin.

When the placing position is the fixed position (No in step S202), the processor 110 specifies a position accuracy required for the object during placing (step S204). For example, the processor 110 specifies whether the position accuracy is optional (that is, unnecessary) or the position accuracy is high.

After step S204, the processor 110 specifies the placement method of the object during placing (step S205). For example, the processor 110 specifies whether to simply place the object in the placing bin or to place the object by joining or fitting the object and another object.

After step S203 or step S205, the processor 110 specifies an orientation of the object during placing (step S206). For example, the processor 110 specifies a predetermined orientation, that is, a fixed orientation, or an orientation that is not predetermined, that is, a free orientation.

The processor 110 determines whether the orientation of the object during placing is the free orientation (step S207).

When the orientation of the object during placing is the fixed orientation (No in step S207), the processor 110 specifies information on a posture change of the object (step S208). The posture change of the object includes, for example, flipping of the object. For example, the processor 110 may specify whether to place the object picked during picking while vertically inverting the object during placing. The processor 110 may freely specify the presence or absence of the posture change of the object.

When the orientation of the object is free in step S207 (Yes in step S207), or after step S208, the processor 110 specifies the presence or absence of the accuracy inspection of the object after placing (step S209).

According to such placing condition specification processing, the automation support apparatus 100 can determine specified contents for various condition items related to placing and specify the placing condition.

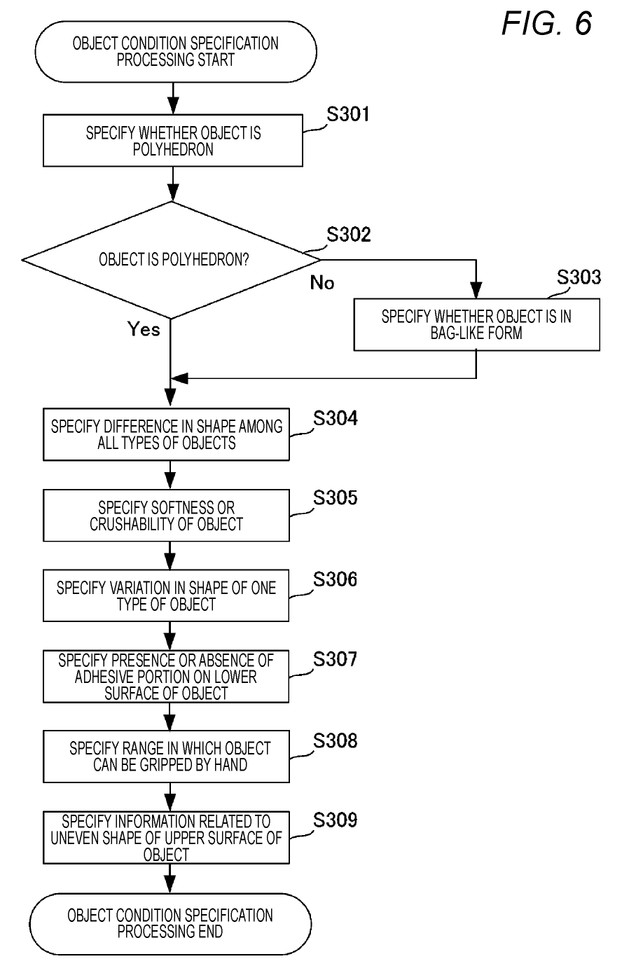

FIG. 6 is a flowchart illustrating an example of the object condition specification processing.

The processor 110 specifies whether the object to be picked and placed is a polyhedron (step S301). The polyhedron includes, for example, a rectangular parallelepiped or a polyhedron formed of many planes. The processor 110 determines whether the object is a polyhedron (step S302).

When the object is not a polyhedron (No in step S302), the processor 110 specifies whether the object is in a bag-like form (step S303).

When the object is a polyhedron (Yes in step S302) or after step S303, the processor 110 specifies information related to a difference in shape among all types of objects to be picked and placed (step S304). For example, the processor 110 specifies whether there is a difference in shape or there is a large difference in shape or there is no difference in shape or there is a small difference in shape depending on the type of the object.

The processor 110 specifies information related to softness or crushability of the object (step S305). For example, the processor 110 specifies the degree of softness or crushability of the object (for example, high or low).

The processor 110 specifies a variation in the shape of one type of object (step S306). For example, the processor 110 specifies whether the variation in the shape of the object is small (for example, regular shape) or large (for example, irregular shape). When there is a plurality of types of objects, the processor 110 may specify whether the variation in the shape of the object is small or large for each type of object.

The processor 110 specifies the presence or absence of an adhesive portion on a lower surface of the object, that is, whether there is an adhesive portion on the lower surface of the object (step S307).

The processor 110 specifies information related to a range in which the object can be gripped by a hand of the robot apparatus (step S308). For example, the processor 110 specifies whether the range in which the object can be gripped by the hand is wide or narrow.

The processor 110 specifies information related to an uneven shape of an upper surface of the object (step S309). For example, the processor 110 may specify whether the unsmooth area on the upper surface of the object is small or large. For example, the processor 110 may specify whether there is an unsmooth area on the upper surface of the object.

According to such object condition specification processing, the automation support apparatus 100 can determine specified contents for various condition items related to the object and specify the object condition.

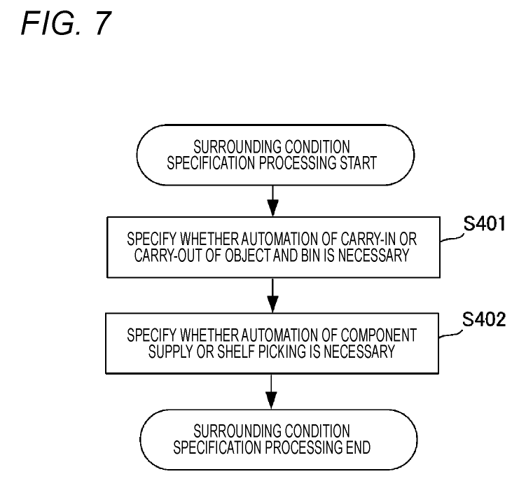

FIG. 7 is a flowchart illustrating an example of the surrounding condition specification processing.

The processor 110 specifies whether automation of carry-in or carry-out of the object or the bin (the picking bin or the placing bin) is necessary (step S401).

The processor 110 specifies whether automation of supply of a component as an object or picking of an object from a shelf is necessary (step S402).

According to such surrounding condition specification processing, the automation support apparatus 100 can determine specified contents for various condition items related to the surrounding work and specify the surrounding condition.

Next, the difficulty level point according to each condition related to the work will be described.

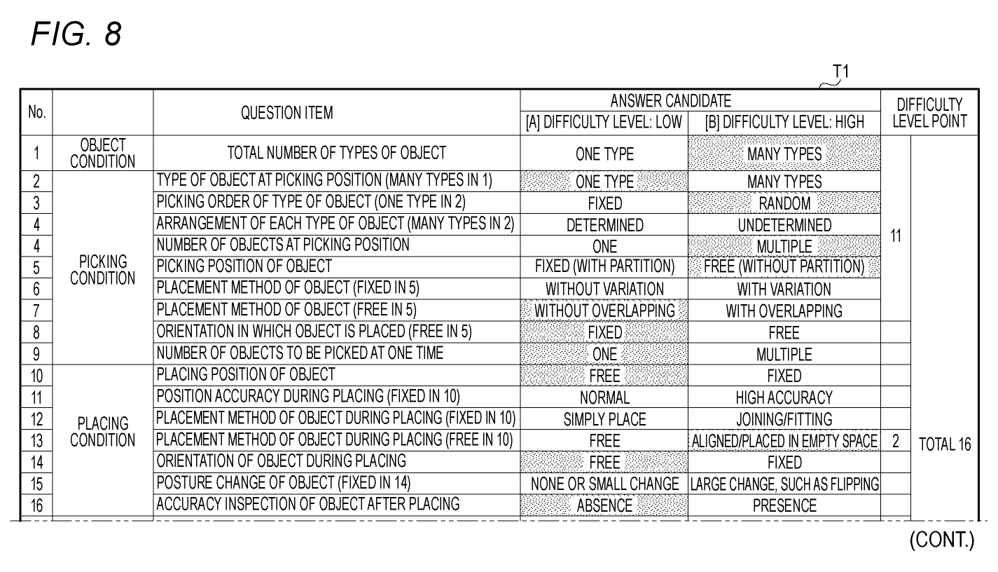

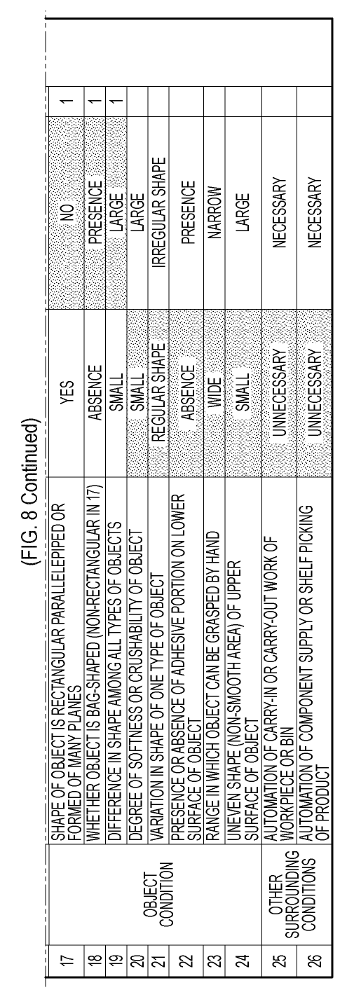

FIG. 8 is a diagram illustrating an example of difficulty level points according to specified contents of each condition related to a work. FIG. 8 is illustrated in a form of a difficulty level point table T1.

The difficulty level point table T1 includes information on question items related to each condition related to a work, information on a specified candidate for each question item (information on an answer candidate), information on a specified content specified for each question item (that is, information on an answer content), a difficulty level point based on the specified content, and an integration difficulty level point based on each difficulty level point, all in association with each other. Conditions related to the work include an object condition, a picking condition, a placing condition, and a surrounding condition. The object condition is classified into nine object condition items. The picking condition is classified into nine picking condition items. The placing condition is classified into seven placing condition items. The surrounding condition is classified into two surrounding condition items. The number of classifications of each condition is not limited thereto. In FIG. 8, the information on the specified contents is displayed with hatching.

In FIG. 8, in the answer candidate column, one row (for example, the left row) illustrates items having a small difficulty level point, that is, a row having a low difficulty level in the automation-required technique (required technique information), and the other row (for example, the right row) illustrates items having a high difficulty level, that is, items having a high difficulty level in the automation-required technique.

In FIG. 8, for each condition item where each condition is classified in detail, information on Item (also referred to as "Item No. **") for identifying the condition item, the question item related to the condition item, the specified candidate (answer candidate) that can be specified for each question item, the specified content (answer content) specified for each question item, and the difficulty level point based on the specified content is included in association with each other.

The processor 110 refers to the difficulty level information database 122 and determines the difficulty level point based on the specified content specified for each condition item. Furthermore, one difficulty level point may be determined collectively for a plurality of condition items. The processor 110 determines an integration difficulty level point, which is a final difficulty level point, based on the determined one or more difficulty level points. For example, the processor 110 determines the integration difficulty level point by adding the determined one or more difficulty level points.

The processor 110 generates the difficulty level point table T1 that includes at least a part of the information on the question items related to each condition (each condition item) related to the work, the specified candidates, the specified contents, the difficulty level points, and the integration difficulty level point, and causes the display device 150 to display the difficulty level point table T1.

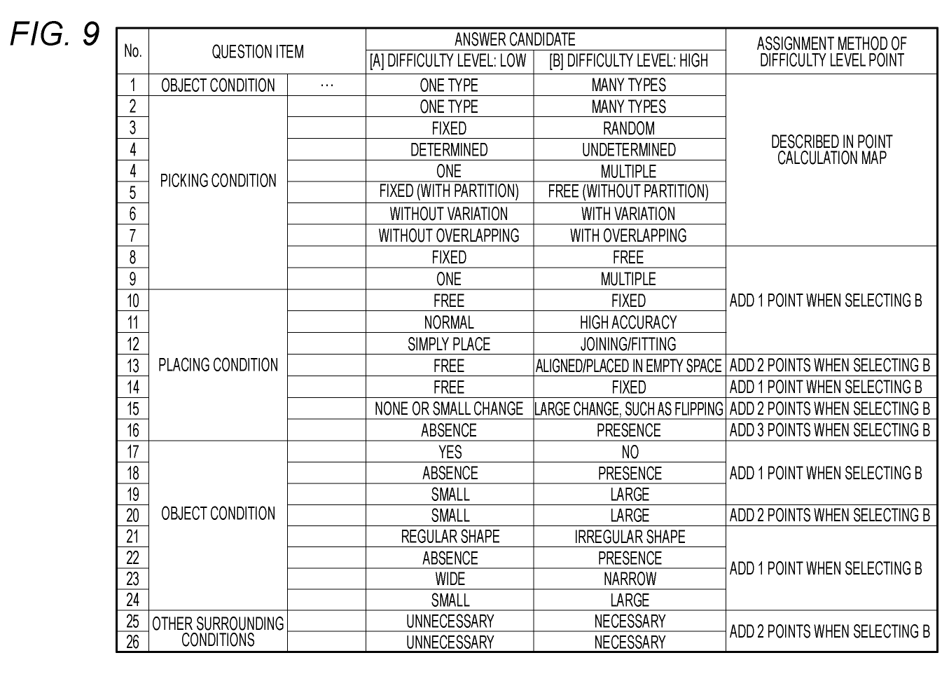

FIG. 9 is a diagram illustrating a method for assigning the difficulty level point according to the specified content for each condition item in a pick-and-place work. In FIG. 9 and subsequent figures, the question items corresponding to the respective Item are omitted, but are specifically the same as the information described in FIG. 8.

The processor 110 assigns the difficulty level point according to the specified content for each condition item in the pick-and-place work. The method of assigning the difficulty level point differs depending on the specified content. For example, 0 points to 3 points are added as the difficulty level points based on the specified content for the condition item. The point values are not limited to these point values and may also be other point values.

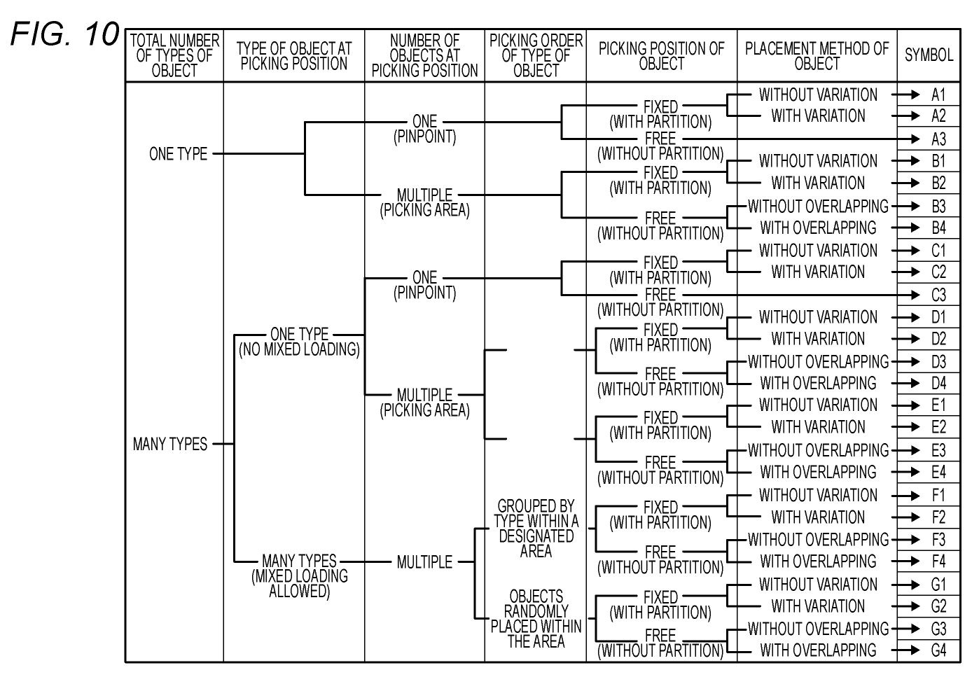

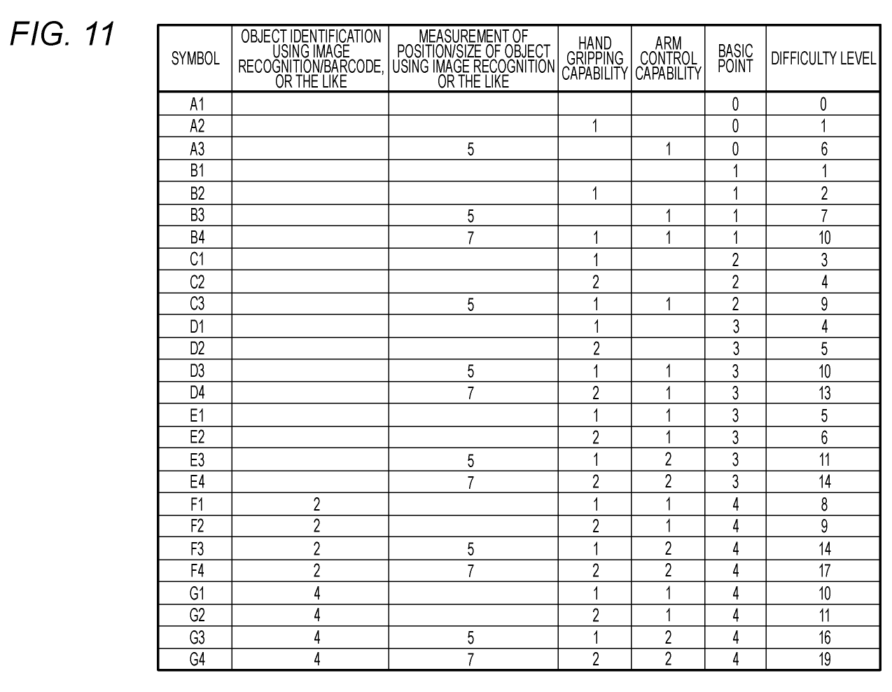

The difficulty level point based on the specified content for each condition item for Item 1 to 7 is based on information (point calculation map) illustrated in FIGS. 10 and 11 described later.

The difficulty level point for each condition item of Item 8 to 12 is added by 1 point when a specified content having a high difficulty level is specified. It can be said that the specified content to which 1 point is added has a higher automation difficulty level than the specified content to which no point is added (that is, 0 points).

The difficulty level point for the condition item of Item 13 is added by 2 points when a specified content having a high difficulty level is specified. It can be said that the specified content to which 2 points are added has a higher automation difficulty level than the specified content to which 1 point is added.

The difficulty level point for the condition item of Item 14 is added by 1 point when a specified content having a high difficulty level is specified.

The difficulty level point for the condition item of Item 15 is added by 2 points when a specified content having a high difficulty level is specified.

The difficulty level point for the condition item of Item 16 is added by 3 points when a specified content having a high difficulty level is specified. It can be said that the specified content to which 3 points are added has a higher automation difficulty level than the specified content to which 2 points are added.

The difficulty level point for each condition item of Item 17 to 19 is added by 1 point when a specified content having a high difficulty level is specified.

The difficulty level point for the condition item of Item 20 is added by 2 points when a specified content having a high difficulty level is specified.

The difficulty level point for each condition item of Item 21 to 24 is added by 1 point when a specified content having a high difficulty level is specified.

The difficulty level point for each condition item of Item 25 and 26 is added by 2 points when a specified content having a high difficulty level is specified.

FIG. 10 is a diagram illustrating an example of difficulty level point symbols according to the specified content for each condition item corresponding to Item 1 to 7 in the pick-and-place work. The difficulty level point is uniquely determined according to the difficulty level point symbol. FIG. 11 is a diagram illustrating an example of technique points, basic points, and difficulty level points related to an automation-required technique according to the specified content corresponding to the difficulty level point symbols.

In FIG. 10, each specified content specified in each condition item corresponding to each of Item 1 to 7 is associated with any pattern, and one difficulty level point symbol is determined according to a combination of the specified contents.

In FIG. 11, examples of the automation-required technique include object identification using image recognition, a barcode, or the like, measurement of the position and size of the object using image recognition or the like, hand gripping capability, and arm control capability. The difficulty level for automating these techniques is indicated by a numerical value as a technique point. The difficulty level point corresponding to the difficulty level point symbol is a total point of each technique point according to the specified content and the basic point. In FIG. 11, a portion where the technique point is 0 is blank, and description thereof is omitted.

As described above, the automation support apparatus 100 can easily derive (for example, calculate) the difficulty level point according to the specified content for each condition item of Item 1 to 7 by preparing in advance the point calculation map illustrated in FIGS. 10 and 11 in which the specified content for each condition item of Item 1 to 7 is taken into account.

The information related to FIGS. 10 and 11 may be stored in the difficulty level information database 122 and may be used to derive the difficulty level point.

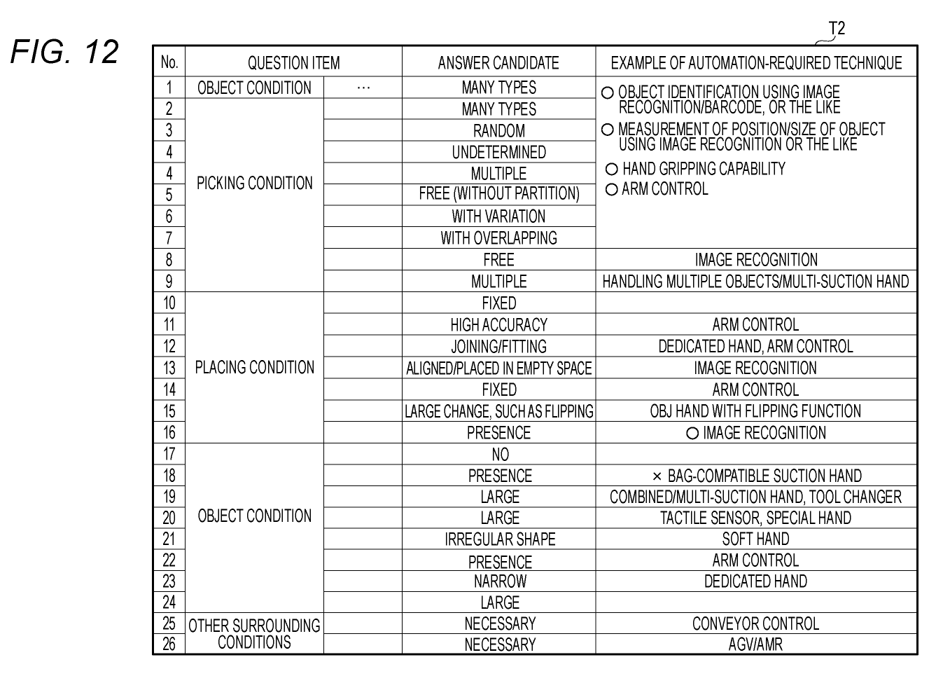

FIG. 12 is a diagram illustrating an example of the automation-required technique according to the specified contents for each condition related to the work. FIG. 12 is illustrated in a form of an automation-required technique table T2. In the automation-required technique table T2 illustrated in FIG. 12, the description of the same information as that of the difficulty level point table T1 illustrated in FIG. 8 will be omitted or simplified.

The automation-required technique table T2 includes information on the question item related to each condition related to the work, the specified content (answer content) specified for each question item, and the automation-required technique based on the specified content in association with each other. Similarly to FIG. 8, in FIG. 12, each condition is classified into condition items. Therefore, specifically, the automation-required technique table T2 includes information on Item for identifying each condition item, the question item related to each condition item, the specified content specified for each question item, and the automation-required technique based on the specified content in association with each other.

In FIG. 12, it may be possible to distinguish whether the automation-required technique is a technique having a past record or a technique having no record. In FIG. 12, it is indicated that a technique marked with a circle (○) is an automation-required technique having a past record, and a technique marked with a cross (×) is an automation-required technique having no record. A technique without a circle mark (○) or a cross mark (×) does not consider the presence or absence of a record. The technique having a record is, for example, a technique included in any piece of automation record information stored in the record information database 125. The technique having no record is, for example, a technique not included in any piece of automation record information stored in the record information database 125.

The processor 110 refers to the required technique information database 123 and determines the automation-required technique based on the specified content specified for each condition item. In addition, one automation-required technique may be determined collectively for a plurality of condition items. Furthermore, the processor 110 may refer to the required technique information database 123 and the record information database 125 and determine only the automation-required technique having a record based on the specified content specified for each condition item.

The processor 110 generates the automation-required technique table T2 including at least a part of the information on the question item related to each condition (each condition item) related to the work, the specified content, and the automation-required technique, and causes the display device 150 to display the automation-required technique table T2.

Even if the numerical value of the difficulty level is simply displayed for the specified content, it is difficult for the user to understand what kind of action should be taken for the automation. Meanwhile, the automation support apparatus 100 can display the required technique information by using the automation-required technique table T2 and can provide the user with useful information related to the automation-required technique by further displaying that there is a record.

The processor 110 may display the required technique information by another method instead of simply displaying at least a part of the information of the automation-required technique table T2. For example, the processor 110 may display the required technique information corresponding to the specified content corresponding to the difficulty level point in a pop-up manner in the vicinity of a display position of the difficulty level point by placing a cursor on the position of the displayed difficulty level point.

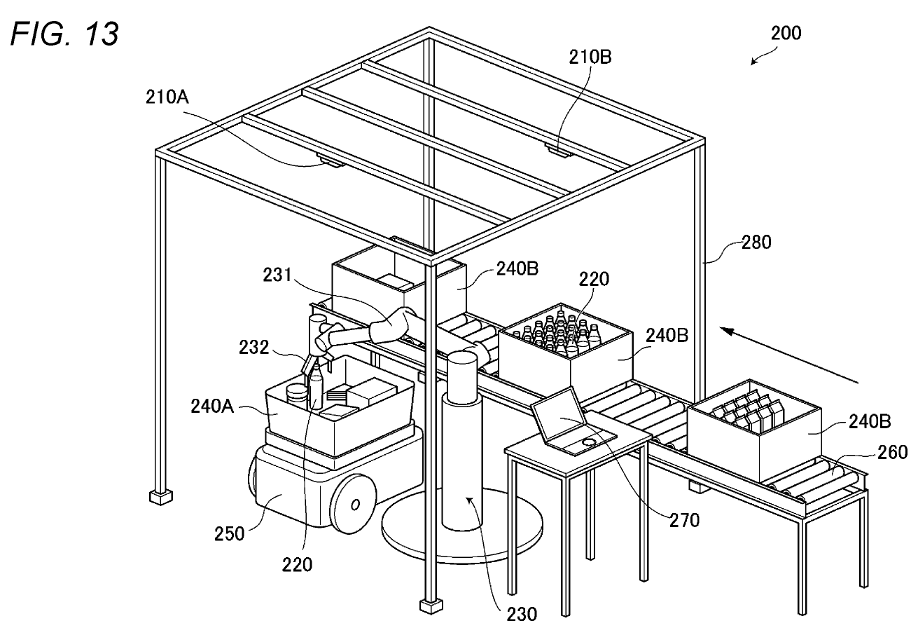

FIG. 13 is a diagram illustrating a configuration example of an automation system 200 (robot system) for automating a predetermined pick-and-place work.

As an example, a pick-and-place work of picking a plurality of types of objects stored in a plurality of picking bins and placing the objects in one placing bin is assumed. In the pick-and-place work, for example, it is assumed that a picking order of the objects is not particularly determined (that is, random) and the objects according to an order are transported. In the pick-and-place work, it is assumed that a bin, which has no partition and allows free placement, is used as the picking bin or the placing bin. At least a part of the assumption here may be included in the specified content (answer content) specified in FIG. 8.

The automation support apparatus 100 performs the operations illustrated in FIGS. 2 to 7 described above to specify the object condition, the picking condition, the placing condition, and the surrounding condition required for the pick-and-place work and determines the difficulty level of automation of the pick-and-place work based on these conditions. Then, the user or the SIer consulted by the user determines whether to automate or not automate each step included in the pick-and-place work in consideration of the determined difficulty level. The automation system 200 that automates the pick-and-place work, that is, the automation system 200 that performs the pick-and-place work is constructed based on the determination of the user or the SIer.

In FIG. 13, as an example, the configuration of the automation system 200 may be determined based on the specified content (answer content) for the question item related to the condition item of each Item illustrated in FIG. 8. That is, each question item may be specified as follows.

Specifically, the total number of types of objects is multiple. There is one type of object at the picking position, and for example, only one type of object is included in one picking bin. The picking order of the types of objects is random. The number of objects at the picking position is multiple. The picking position of the object is free, and there is no partition. The placement method of the object does not involve overlapping. The number of objects to be picked at one time is one. The placing position of the object is free. Regarding the placement method of the object during placing, the objects are aligned and placed in an empty space. The orientation of the object during placing is free. There is no accuracy inspection for the object after placing. The shape of the object is not a rectangular parallelepiped or not formed of many planes. The object has a bag-like shape. There is a large difference in shape among all types of objects. The degree of softness or crushability of the object is small. There is little variation in the shape of one type of object, and the shape is regular. There is no adhesive portion on the lower surface of the object. A range in which the object can be grasped by a hand (robot hand) is wide. The uneven shape (non-smooth area) of the upper surface of the object is small. It is not necessary to automate the work of carrying in or out the workpiece or the bin. It is not necessary to automate the supply of components or the shelf picking of products.

The automation system 200 illustrated in FIG. 13 is constructed based on the above specified contents. In the constructed automation system 200, as an example, a conveyor 260 is provided, and a plurality of picking bins 240A are transported on the conveyor 260 from a warehouse. Each of the plurality of picking bins 240A stores only one type of different objects 220. The automation system 200 is provided with, for example, an autonomous mobile robot (AMR) that can move in the warehouse, and placing bins 240B can be placed on the AMR. One or more types of objects picked from the picking bin 240A are placed in the placing bin 240B. Furthermore, the automation system 200 is provided with a robot apparatus 230 that picks, moves, and places the object. The robot apparatus 230 includes a robot arm 231 and a robot hand 232. The automation system 200 is provided with a picking camera 210A and a placing camera 210B, and the picking camera 210A and the placing camera 210B are installed in a frame 280. Furthermore, the automation system 200 is provided with a PC 270 that controls and manages the pick-and-place work and various devices in the automation system 200.

Furthermore, another configuration of the automation system 200 (configuration other than the configuration illustrated in FIG. 13) may be determined based on the specified content (answer content) for the question item related to the condition item of each Item illustrated in FIG. 8. That is, each question item may be specified as follows. Here, a part of the specified content is extracted and illustrated.

Specifically, the total number of types of objects is five, for example, products 1 to 5. There are two types of objects at the picking position. Here, the fact that there are two types of objects at the picking position indicates that there are at most two types of objects at the picking position and may include a case in which there is one type of object at the picking position. The picking position may be different for each picking bin and may be the position of each picking bin. For example, the product 1 can be stored in a picking bin A, the product 2 and the product 3 can be stored in a picking bin B, and the product 4 and the product 5 can be stored in a picking bin C. Based on such specified contents, it is possible to construct the automation system 200 in which the robot apparatus can perform picking using three picking bins (for example, picking bins A to C).

As described above, the automation support apparatus 100 according to the present embodiment specifies (for example, inputs) the object condition of the object to be picked and placed, the picking condition and the placing condition represented by the movement of the object, and the surrounding condition associated with the pick-and-place, for example, in an initial stage in which the user considers the automation of the pick-and-place work. Accordingly, the automation support apparatus 100 can quantitatively evaluate the difficulty level of automation for executing the work by the robot system with the difficulty level point. In addition, the automation support apparatus 100 calculates the difficulty level point of automation for each input value (specified content) of each condition and displays information on the automation-required technique as a solution for a condition item to which the difficulty level point is added.

Furthermore, for example, when the difficulty level point is high, the automation support apparatus 100 displays the SIer information of the system integrator capable of handling the automation-required technique registered in advance. For example, the SIer information may be displayed in order to consult the system integrator with the automation of the specified content in which the difficulty level point is 10 or more. As an example, the processor 110 may classify a difficulty level point of 10 or more as a high difficulty level rank. As an example, a difficulty level point of 0 may be considered as a rank with a low difficulty level, a difficulty level point of 1 to 9 may be considered as a rank with a medium difficulty level, and a difficulty level point of 10 or more may be considered as a rank with a high difficulty level.

In this way, the automation support apparatus 100 allows the user to grasp the difficulty level when automating a target manual work, even if the user does not have specialized knowledge about a robot apparatus or automation. Therefore, the automation support apparatus 100 can determine whether the work can be automated and select a process to be automated or a process. In addition, the user can quickly confirm that automation is difficult when the difficulty level is high, and automation is easy when the difficulty level is low.

The processor 110 may cause the display device 150 to display a change in the difficulty level point based on the specified content while changing the specified content of each condition related to the work via the input device 140, for example. Accordingly, the user can easily confirm how the difficulty level changes when the specified content of a certain condition (condition item) is changed. Therefore, the automation support apparatus 100 enables the user to easily consider how to change the specified content to approach the difficulty level point (for example, 15 points) of the target line for automation.

In addition, the automation support apparatus 100 displays the required technique information as the information on the solution for the item to which the difficulty level point is added (that is, the condition item in which the difficulty level point is equal to or larger than a threshold th1 (for example, 1 point), so that the user can easily grasp the automation-required technique.

In addition, when the difficulty level point is high, for example, when the difficulty level point is equal to or larger than a threshold th2 (for example, 10 points), the automation support apparatus 100 can provide the SIer information of the system integrator that can handle the automation-required technique corresponding to the specified content of the difficulty level point. The user can check the SIer information and consult with the SIer to receive advice or support for automation of the pick-and-place work that is difficult for the user to implement. Therefore, even if the user does not have technical knowledge, the user can request an appropriate SIer to receive support for a work with a high difficulty level and can select that the user himself/herself automates the work with a low difficulty level. The SIer side also does not need to hear the system requirements from the first stage and can hear the automation from the user or the like after grasping the notified specified content. Therefore, the burden associated with automation of work executed by the SIer can be reduced.

### Second Embodiment

In the present embodiment, a description will be given of a case in which the difficulty level of automation of a plurality of pick-and-place works are compared.

Since the configuration of the automation support apparatus 100 according to the present embodiment is the same as the configuration of the automation support apparatus 100 according to the first embodiment illustrated in FIG. 1, the description thereof will be omitted or simplified.

Next, an operation of the automation support apparatus 100 according to the present embodiment will be described.

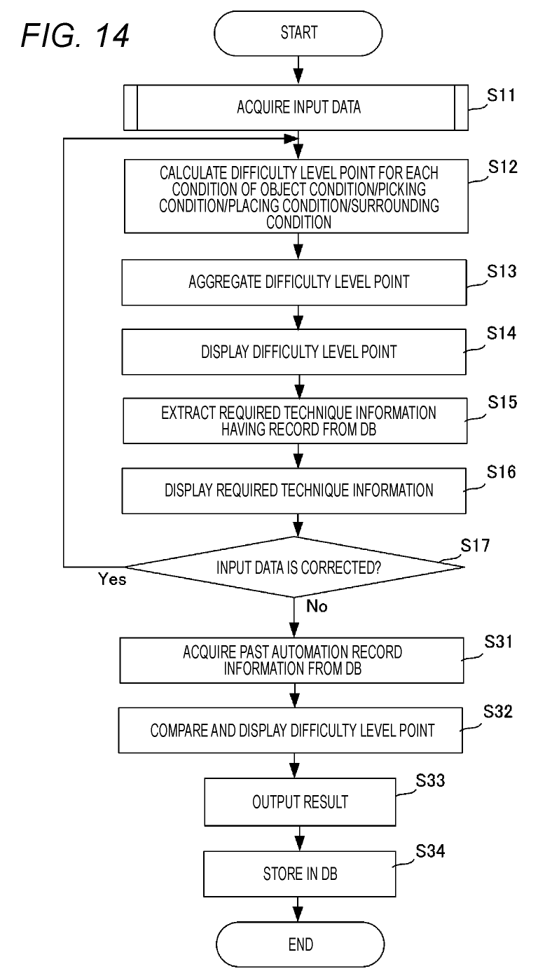

FIG. 14 is a flowchart illustrating an operation example of the automation support apparatus 100 according to the present embodiment. In FIG. 14, automation of a plurality of pick-and-place works is assumed.

First, the processor 110 executes the processing of steps S11 to S17 illustrated in FIG. 2.

The processor 110 reads and acquires automation record information generated and accumulated in the past from the record information database 125 (step S31). The automation record information includes information on difficulty level points. The processor 110 may select desired automation record information from a plurality of pieces of automation record information via the input device 140.

The processor 110 displays the automation specification information generated in steps S11 to S16 and the automation record information acquired in step S31 side by side on, for example, the display device 150 to perform comparative display. In this case, the processor 110 compares and displays at least the difficulty level point included in the automation specification information with the difficulty level point included in the automation record information (step S32).

The processor 110 outputs information on a comparison result between the automation specification information and the automation record information (step S33). The output here may include transmitting the information on the comparison result to an external apparatus via the communication device 130.

The processor 110 stores the information on the comparison results in the record information database 125 (step S34). The processor 110 may store the automation specification information (current automation specification information) generated in steps S11 to S16 in the record information database 125 as automation record information.

According to the operation example illustrated in FIG. 14, the automation support apparatus 100 can provide the user with information such as the ease of automation based on the difficulty level points and the ease of introduction of required technique information for a plurality of pick-and-place works.

Next, a specific example of a plurality of pick-and-place works will be described. Here, pick-and-place works W1 and W2 will be exemplified.

The work W1 is a work of inverting and storing many types (for example, ten or more types) of components having complicated shapes from a dedicated tray (an example of a picking bin) in which components are stored by type to a blister pack (an example of a placing bin). In the dedicated tray, a plurality of pockets are formed by partitioning an internal space. In the respective pockets, a plurality of types of components are stored by type, that is, one or more components of one type are stored in one pocket. In each pocket, there is a gap allowing the stored component to move. It is assumed that such a work W1 is automated.

The work W2 is a work of removing an electronic component from a component case (an example of a picking bin) in which a plurality of the electronic components are stored in bulk in order to mount one type of electronic components on a circuit board, and inserting the terminals of the electronic component into the via holes of the circuit board. It is assumed that such work W2 is automated.

In order to automate the two different works W1 and W2, the processor 110 determines a specified content for each condition related to the work for each of the works W1 and W2 and calculates a difficulty level point based on the specified content. Then, the processor 110 causes the display device 150 to display the difficulty level points of the two works W1 and W2 such that the difficulty level points can be compared. Then, the processor 110 causes the display device 150 to display the specified content and the difficulty level point side by side for the condition item to which the difficulty level point based on the specified content specified for each condition related to the work is added (that is, the condition item in which the difficulty level point is one or more points). Accordingly, the automation support apparatus 100 can provide information indicating which work of the two pick-and-place works W1 and W2 is easier to automate.

For example, the automation support apparatus 100 compares and displays information on a condition item having a high difficulty level point in each of the conditions of both of the pick-and-place works W1 and W2. Accordingly, the user can determine which of the two works W1 and W2 is easier to prepare the automation-required technique.

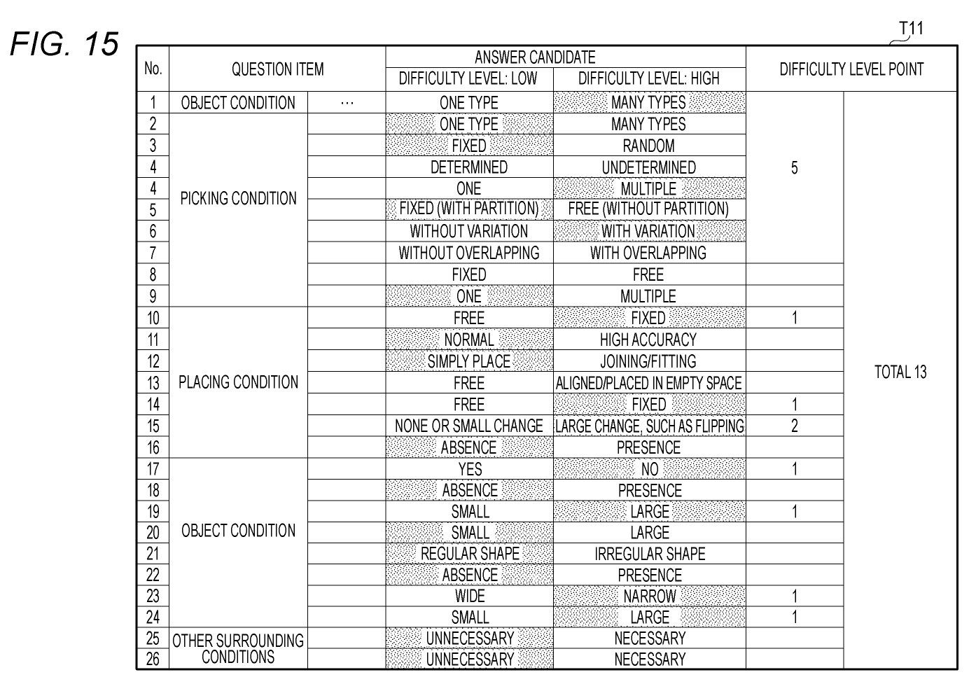

FIG. 15 is a diagram illustrating an example of the difficulty level point related to the work W1.

FIG. 15 is illustrated in a form of a difficulty level point table T11.

Since the information included in the difficulty level point table T11 is the same as the information included in the difficulty level point table T1 illustrated in FIG. 8, detailed description thereof will be omitted. For the work W1, the processor 110 generates the difficulty level point table T11 including information on each condition (each condition item) related to the work, the specified candidate, the specified content, the difficulty level point, and the integration difficulty level point, and causes the display device 150 to display the difficulty level point table T11.

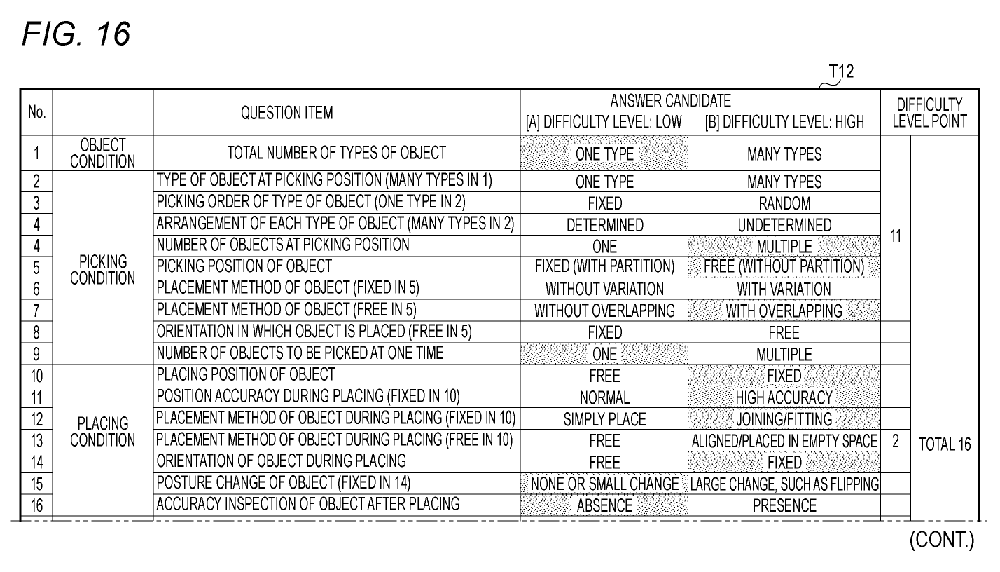

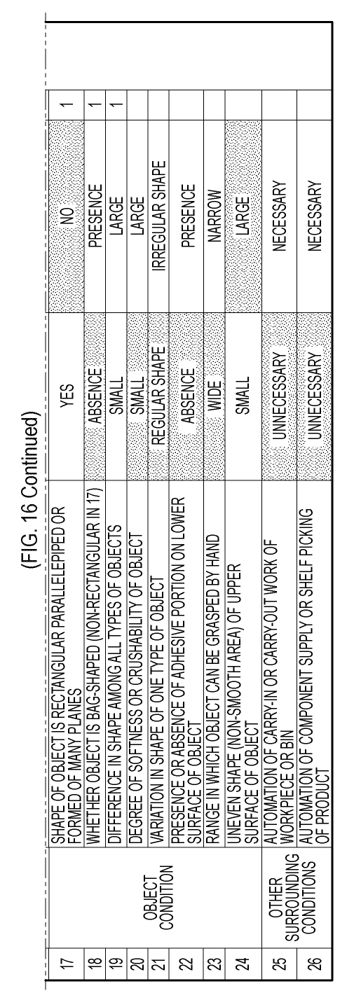

FIG. 16 is a diagram illustrating an example of the difficulty level point related to the work W2.

FIG. 16 is illustrated in a form of a difficulty level point table T12.

Since the information included in the difficulty level point table T12 is the same as the information included in the difficulty level point table T1 illustrated in FIG. 8, detailed description thereof will be omitted. For the work W2, the processor 110 generates the difficulty level point table T12 including information on each condition (each condition item) related to the work, the specified candidate, the specified content, the difficulty level point, and the integration difficulty level point, and causes the display device 150 to display the difficulty level point table T12.

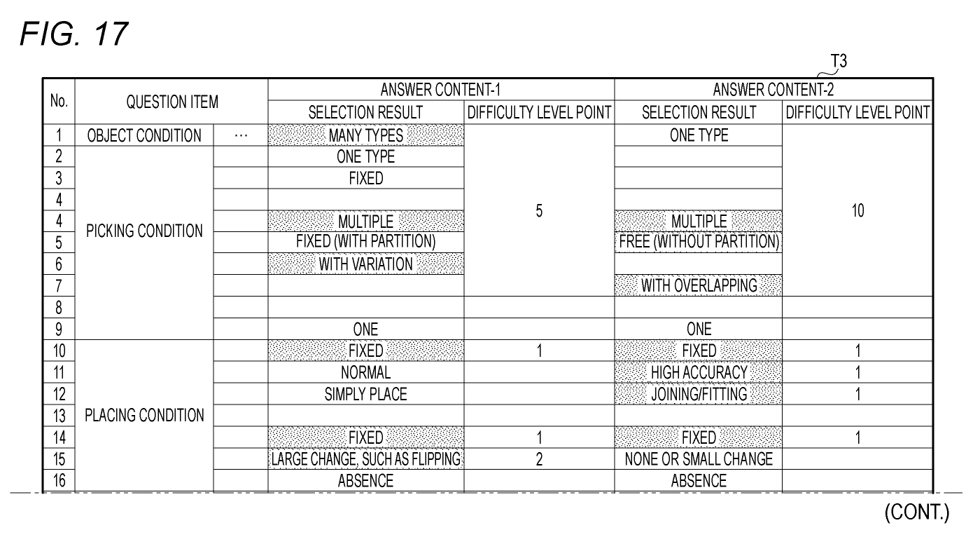

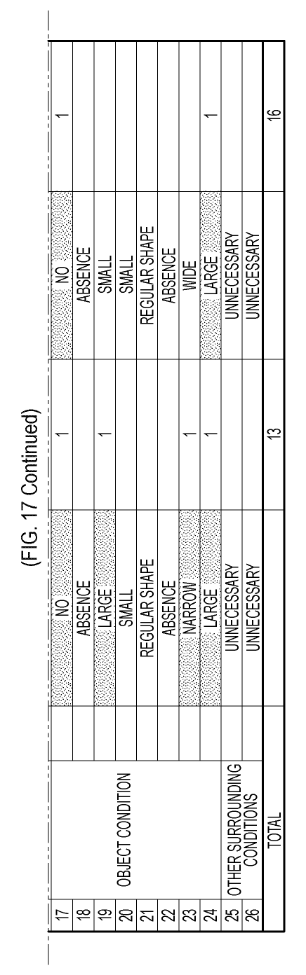

FIG. 17 is a diagram illustrating a comparative example of the difficulty level points of the two works W1 and W2. FIG. 17 is illustrated in a form of a difficulty level point comparison table T3. In FIG. 17, the description of the same items as those of each table described above will be omitted or simplified.

In FIG. 17, each condition (condition item), the specified content, and the difficulty level point based on the specified content in the works W1 and W2 are stored in association with each other. In FIG. 17, for each of the works W1 and W2, a selection result and the difficulty level point for each condition (condition item) are illustrated. The processor 110 may collectively determine one difficulty level point for a plurality of condition items. The processor 110 generates the difficulty level point comparison table T3 including at least a part of the information on each condition related to the work, the specified content for each of the works W1 and W2, and the difficulty level point for each of the works W1 and W2 and causes the display device 150 to display the difficulty level point comparison table T3. The displayed information includes at least information on the difficulty level point of each of the works W1 and W2. The difficulty level point comparison table T3 may include information on the integration difficulty level point for each of the works W1 and W2.

Therefore, by checking the display of the difficulty level point comparison table T3, the user can compare and check the difficulty level points and the integration difficulty level points of the plurality of pick-and-place works W1 and W2. Therefore, the user can intuitively determine which work is easier to automate.

As described above, according to the automation support apparatus 100 of the present embodiment, it is possible to quantitatively compare the automation difficulty levels of different works, and thus it is easy to narrow down the work to be automated. In addition, since the automation support apparatus 100 can accumulate the derived information on the automation difficulty level and the required technique information corresponding to the high difficulty level in the record information database 125 as the record, the automation support apparatus 100 can develop and accumulate the elemental technique for automation and use it as a database.

In the operation example illustrated in FIG. 14, the two works to be compared are the work related to the automation specification information derived this time and the work related to the automation record information derived in the past, but the present disclosure is not limited thereto. For example, the processor 110 may be configured such that all of the plurality of works to be compared are a plurality of works related to the plurality of pieces of automation record information stored in the record information database 125. Furthermore, for example, the processor 110 may be configured such that all of the plurality of works to be compared are a plurality of works related to the plurality of pieces of automation specification information derived this time.

### Other Embodiments

In the first embodiment and the second embodiment, an example has been given in which, as input data, data in which the specified content is specified by selecting one option from among a plurality of options is mainly acquired, but the present disclosure is not limited thereto. For example, the processor 110 may acquire an image related to a pick-and-place work as the input data. For example, a predetermined imaging device may image a state in which a person is performing a pick-and-place work that the user desires to automate. In the automation support apparatus 100, the processor 110 may acquire the captured image as the input data via the communication device 130.

Then, the processor 110 may determine the specified content of each condition item for each of the object condition, the picking condition, the placing condition, and the surrounding condition based on the image as the input data using a predetermined trained model. For example, the processor 110 may generate the trained model by setting an image in which the pick-and-place work is captured and the specified contents of the object condition, the picking condition, the placing condition, and the surrounding condition represented by the image as a pair as learning data and causing a learning model to learn using a large amount of learning data. The trained model may be, for example, a large language model (LLM) or a vision language model (VLM).

As described above, the automation support apparatus 100 can reduce the burden on the user related to the input work (work of determining the specified content) and evaluate the difficulty level of automation of the work by using the image in which the state of the work desired to be automated is captured as the input data.

### Overview of Embodiment

As described above, at least the following matters are described in the present disclosure. Components corresponding to those in the above embodiment are shown in parentheses, but the present disclosure is not limited thereto.

### Item 1

An automation support apparatus (automation support apparatus 100) for supporting automation of a pick-and-place work, the automation support device including:
a memory (memory 120) storing instructions; and
a processor(processor 110) that implements the instructions to
   specify an object condition related to an object to be picked and placed, a picking condition related to picking of the object, and a placing condition related to placing of the object,
   determine a quantitative difficulty level for automating the work based on the specified object condition, picking condition, and placing condition, and
   cause a display device (display device 150) to display the quantitative difficulty level.

Accordingly, the automation support apparatus can accurately derive the difficulty level of automation by taking into account various conditions related to the work. The automation support apparatus can provide the user with information related to the difficulty level when automating the manual work even if the user does not have specialized knowledge about a robot apparatus or automation. Therefore, the automation support apparatus can determine whether the work can be automated and select a process to be automated or a process. Furthermore, the automation support apparatus can ensure the suitability of the automation system determined based on the difficulty level.

### Item 2

The automation support apparatus according to item 1, in which
the processor implements the instructions to
   specify a surrounding condition related to a surrounding work associated with the pick-and-place of the object, and
   determine the quantitative difficulty level based on the specified object condition, picking condition, placing condition, and surrounding condition.

Accordingly, the automation support apparatus can evaluate the difficulty level of automation of the work by taking into account not only the process in the pick-and-place work but also the surrounding condition related to the surrounding work required for performing the pick-and-place.

### Item 3

The automation support apparatus according to item 2, in which
the processor implements the instructions to
   calculate a first difficulty level point for automating the work based on the specified object condition,
   calculate a second difficulty level point for automating the work based on the specified picking condition,
   calculate a third difficulty level point for automating the work based on the specified placing condition,
   calculate a fourth difficulty level point for automating the work based on the specified surrounding condition, and
   determine the quantitative difficulty level based on the first difficulty level point, the second difficulty level point, the third difficulty level point, and the fourth difficulty level point.

Accordingly, the automation support apparatus can derive the difficulty level point for each condition related to the work and quantitatively derive the final difficulty level.

### Item 4

The automation support apparatus according to item 2 or 3, in which
the object condition, the picking condition, the placing condition, and the surrounding condition each include one or more condition items, and
the processor implements the instructions to cause the display device to display, for each of the condition items, a difficulty level point corresponding to a specified content specified in the condition item.

Accordingly, the automation support apparatus can derive each difficulty level point such as a subdivided process by specifying a detailed condition according to the condition item obtained by subdividing the condition related to the work and determining the specified content. Furthermore, the automation support apparatus can notify the user of a portion having a high difficulty level in the work by displaying the subdivided difficulty level points.

### Item 5

The automation support apparatus according to item 4, in which
the processor implements the instructions to cause the display device to display information on a solution for achieving the specified content of the condition item for which the difficulty level point is equal to or larger than a threshold (one point) (required technique information).

Accordingly, the automation support apparatus can notify the user of, for example, a technique required for achieving the specified content having a high difficulty level.

### Item 6

The automation support apparatus according to item 4 or 5, in which
the processor implements the instructions to
   rank the specified content of each condition item according to the difficulty level point, and
   cause the display device to display information related to a system integrator configured to automate the specified content corresponding to the difficulty level point (SIer information) when the difficulty level point is included in a rank equal to or larger than a predetermined standard (a rank having a high difficulty level).

Accordingly, for example, in a case in which the difficulty level point is high for the specified content of the condition item, the automation support apparatus can provide the user with the information on the system integrator which is an expert of the automation of the work. Therefore, the user can receive advice or the like from the system integrator for the work portion having a high difficulty level.

### Item 7

The automation support apparatus according to any one of items 1 to 6, in which
the processor implements the instructions to
   acquire an image captured of the pick-and-place of the object, and
   specify the object condition, the picking condition, and the placing condition based on the image.

Accordingly, the automation support apparatus can reduce the burden on the user for automating the work by, for example, automatically specifying the condition related to the work based on the image in which the state of the pick-and-place is captured, instead of the user answering one question items with respect to the condition items one by one.

### Item 8

An automation support method for supporting automation of a pick-and-place work, the automation support method including:
specifying an object condition related to an object to be picked and placed, a picking condition related to picking of the object, and a placing condition related to placing of the object;
determining a quantitative difficulty level for automating the work based on the specified object condition, picking condition, and placing condition; and
causing a display device to display the quantitative difficulty level.

Thereby, the same effect as that of item 1 is obtained.

Although various embodiments are described above with reference to the drawings, it is needless to say that the present disclosure is not limited to such examples. It is apparent that those skilled in the art can conceive of various modifications or corrections within the scope described in the claims, and it is understood that such modifications or corrections naturally fall within the technical scope of the present disclosure. The components in the above embodiments may be freely combined without departing from the scope of the invention.

### INDUSTRIAL APPLICABILITY

The present disclosure is useful for an automation support apparatus and an automation support method that can evaluate the difficulty level of automating a work by taking into account various conditions related to pick-and-place.

What is claimed is:

1. An automation support apparatus for supporting automation of a pick-and-place work, the automation support device comprising:
a memory storing instructions; and
a processor that implements the instructions to
specify an object condition related to an object to be picked and placed, a picking condition related to picking of the object, and a placing condition related to placing of the object,
determine a quantitative difficulty level for automating the work based on the specified object condition, picking condition, and placing condition, and
cause a display device to display the quantitative difficulty level.

2. The automation support apparatus according to claim 1, wherein
the processor implements the instructions to
specify a surrounding condition related to a surrounding work associated with the pick-and-place of the object, and
determine the quantitative difficulty level based on the specified object condition, picking condition, placing condition, and surrounding condition.

3. The automation support apparatus according to claim 2, wherein
the processor implements the instructions to
calculate a first difficulty level point for automating the work based on the specified object condition,
calculate a second difficulty level point for automating the work based on the specified picking condition,
calculate a third difficulty level point for automating the work based on the specified placing condition,
calculate a fourth difficulty level point for automating the work based on the specified surrounding condition, and
determine the quantitative difficulty level based on the first difficulty level point, the second difficulty level point, the third difficulty level point, and the fourth difficulty level point.

4. The automation support apparatus according to claim 2, wherein
the object condition, the picking condition, the placing condition, and the surrounding condition each include one or more condition items, and
the processor implements the instructions to cause the display device to display, for each of the condition items, a difficulty level point corresponding to a specified content specified in the condition item.

5. The automation support apparatus according to claim 4, wherein
the processor implements the instructions to cause the display device to display information on a solution for achieving the specified content of the condition item for which the difficulty level point is equal to or larger than a threshold.

6. The automation support apparatus according to claim 4, wherein
the processor implements the instructions to
rank the specified content of each condition item according to the difficulty level point, and
cause the display device to display information related to a system integrator configured to automate the specified content corresponding to the difficulty level point when the difficulty level point is included in a rank equal to or larger than a predetermined standard.

7. The automation support apparatus according to claim 1, wherein
the processor implements the instructions to
acquire an image captured of a subject including the object, and
specify the object condition, the picking condition, and the placing condition based on the image.

8. An automation support method for supporting automation of a pick-and-place work, the automation support method comprising:
specifying an object condition related to an object to be picked and placed, a picking condition related to picking of the object, and a placing condition related to placing of the object;
determining a quantitative difficulty level for automating the work based on the specified object condition, picking condition, and placing condition; and
causing a display device to display the quantitative difficulty level.
